(19) United States
(12) Patent Application Publication
(10) Pub. No.: US 2009/0119614 A1
(43) Pub. Date: May 7, 2009

(54) Method, Apparatus and Computer Program Product for Heirarchical Navigation with Respect to Content Items of a Media Collection

(75) Inventors: Vesa Tienvieri, Tampere (FI); Ilari Lahteenmaki, Tampere (FI); Antti Sorvari, Itasalmi (FI); Jukka-Pekka Salmenkaita, Helsinki (FI); Tomi Myllyla, Espoo (FI); Joonas Paalasmaa, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/936,233

(22) Filed: Nov. 7, 2007

(51) Int. Cl. G06F 3/048

(52) U.S. Cl. 715/786

(57) ABSTRACT

An apparatus for providing hierarchical navigation with respect to content items of a media collection may include a processing element. The processing element may be configured to provide a hierarchical organization of content items in which each of the content items is organized according to type and, within each type, the content items are further organized according to categories. Each of the categories may represent a different basis upon which to organize the content items. The processing element may be further configured to enable a user to view content items within a particular category using a first scrolling function oriented with respect to a first axis, and enable the user to switch categories using a second scrolling function oriented with respect to a second axis.

### TECHNOLOGICAL FIELD

Embodiments of the present invention relate generally to content management technology and, more particularly, relate to a method, apparatus and computer program product for providing hierarchical navigation with respect to content items of a media collection.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices. As mobile electronic device capabilities expand, a corresponding increase in the storage capacity of such devices has allowed users to store very large amounts of content on the devices. Given that the devices will tend to increase in their capacity to store content and/or receive content relatively quickly upon request, and given also that mobile electronic devices such as mobile phones often face limitations in display size, text input speed, and physical embodiments of user interfaces (UI), challenges are created in content management. Specifically, an imbalance between the development of capabilities related to storing and/or accessing content and the development of physical UI capabilities may be perceived.

An example of the imbalance described above may be realized in the context of content management and/or selection. In this regard, for example, if a user has a very large amount of content stored in electronic form, it may be difficult to sort through the content in its entirety either to search for content to render or merely to browse the content. This is often the case because content is often displayed in a one dimensional list format. As such, only a finite number of content items may fit in the viewing screen at any given time. Scrolling through content may reveal other content items, but at the cost of hiding previously displayed content items.

In order to improve content management capabilities, metadata or other tags may be automatically or manually applied to content items in order to describe or in some way identify a content item as being relevant to a particular subject. As such, each content item may include one or more metadata tags that may provide a corresponding one or more relevancies with which the corresponding content item may be associated. Thus, for some content, such as, for example, a gallery of pictures, a grid or list of content items may be displayed based on the metadata. However, even when a gallery of content items is displayed, it is common for the contents of the gallery or the list to be arranged based on a single criteria (or a single metadata tag) such as date, location, individual creating or in the content item, genre, album, artist, and so on.

Users may desire an opportunity to more easily review their content in a manner that permits a seamless shift between different types of content and/or content related to different topics or subjects. Although a user may select a different criteria to serve as the basis for the list or gallery of content items, or to serve as the basis for scrolling between content items (e.g., in a grid), the selection of the different criteria typically requires excessive user interface. In this regard, for example, the user may be required to access a separate menu for selection of a new criteria. Additionally or alternatively, the user may be required to type in a text identifier of the new criteria. Accordingly, users may perceive the selection of the different criteria to be an impediment to effectively and efficiently browsing their content. Thus, only a minimal or at least partial portion of a collection of content items may ultimately be browsed, played or utilized. This may be true whether the collection relates to music, movies, pictures or virtually any type of content.

Thus, it may be advantageous to provide an improved hierarchical navigation mechanism for content items of a media collection, which may provide improved content management for operations such as searching, browsing, playing, editing and/or organizing content.

### BRIEF SUMMARY

A method, apparatus and computer program product are therefore provided to enable hierarchical navigation with respect to content items of a media collection. In particular, some embodiments of the present invention may provide a method, apparatus and computer program product that may enable an organization of content items that may be of one or of various types in a hierarchical manner in which various categories which may correspond to different levels of organization are provided. Each category may represent a different basis upon which to organize the content items. Within each category, items may be viewed sequentially by executing a scrolling function along a particular direction or axis. Meanwhile, by executing a scrolling function in a direction or axis different than the particular direction or axis, the user may seamlessly shift to a different category.

Embodiments of the invention may provide a method, apparatus and computer program product for advantageous employment, for example, in content management environments including a mobile electronic device environment, such as on a mobile terminal capable of creating and/or viewing content items and objects related to various types of media. As a result, for example, mobile terminal users may enjoy an improved content management capability and a corresponding improved ability to select and experience content and/or links related to particular content.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of portions of an apparatus for providing hierarchical navigation with respect to content items of a media collection according to an exemplary embodiment of the present invention;

FIG. 4 illustrates an example of an organizational hierarchy according to an exemplary embodiment of the present invention;

FIG. 5 illustrates an example of a display of items corresponding to categories according to an exemplary embodiment of the present invention;

FIG. 6 illustrates an example of a display of a play view according to an exemplary embodiment of the present invention;

FIG. 7 illustrates an example of content items within a particular category according to an exemplary embodiment;

FIG. 8 illustrates an example of a video or image media type content item according to an exemplary embodiment of the present invention;

FIG. 9 illustrates an example of a plurality of content items within a given level of organization being displayed in accordance with embodiments of the present invention;

FIG. 10 illustrates an example of an associative browsing function that may be performed in accordance with embodiments of the present invention;

FIG. 11 illustrates an example of a change in mode with respect to functions associated with a scroller according to an exemplary embodiment of the present invention; and

FIG. 12 is a flowchart according to an exemplary method for providing hierarchical navigation with respect to content items of a media collection according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

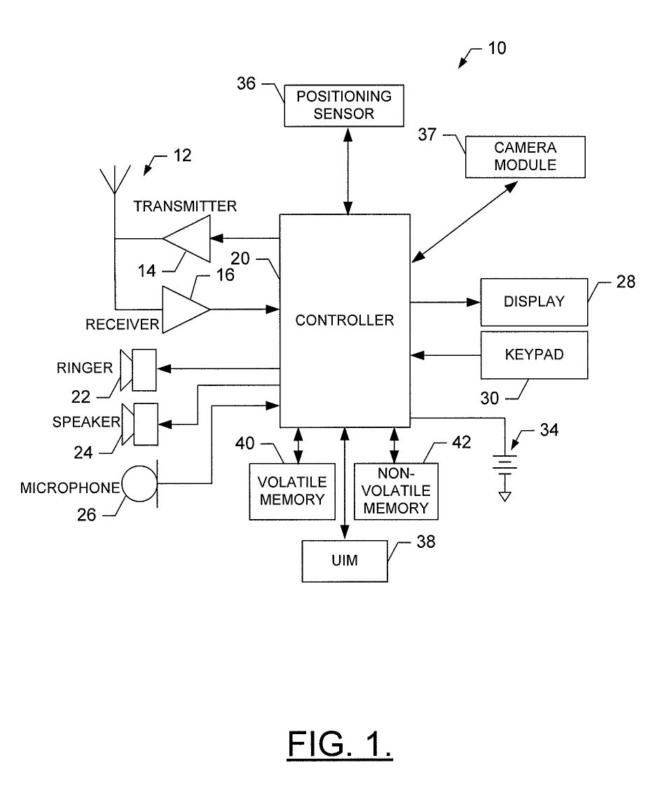

FIG. 1, one aspect of the invention, illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, GPS devices, media players, content playable devices, internet devices or any combination of the aforementioned, and other types of voice and text communications systems, can readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with fourth-generation (4G) wireless communication protocols or the like.

It is understood that the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output. In addition, the mobile terminal 10 may include a positioning sensor 36. The positioning sensor 36 may include, for example, a global positioning system (GPS) sensor, an assisted global positioning system (Assisted-GPS) sensor, etc. However, in one exemplary embodiment, the positioning sensor 36 includes a pedometer or inertial sensor. In this regard, the positioning sensor 36 is capable of determining a location of the mobile terminal 10, such as, for example, longitudinal and latitudinal directions of the mobile terminal 10, or a position relative to a reference point such as a destination or start point. Information from the positioning sensor 36 may then be communicated to a memory of the mobile terminal 10 or to another memory device to be stored as a position history or location information.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication. In conjunction with the positioning sensor 36, the cell id information may be used to more accurately determine a location of the mobile terminal 10.

In an exemplary embodiment, the mobile terminal 10 includes a media capturing module, such as a camera, video and/or audio module, in communication with the controller 20. The media capturing module may be any means for capturing an image, video and/or audio for storage, display or transmission. For example, in an exemplary embodiment in which the media capturing module is a camera module 37, the camera module 37 may include a digital camera capable of forming a digital image file from a captured image. As such, the camera module 37 includes all hardware, such as a lens or other optical device, and software necessary for creating a digital image file from a captured image. Alternatively, the camera module 37 may include only the hardware needed to view an image, while a memory device of the mobile terminal 10 stores instructions for execution by the controller 20 in the form of software necessary to create a digital image file from a captured image. In an exemplary embodiment, the camera module 37 may further include a processing element such as a co-processor which assists the controller 20 in processing image data and an encoder and/or decoder for compressing and/or decompressing image data. The encoder and/or decoder may encode and/or decode according to, for example, a joint photographic experts group (JPEG) standard or other format.

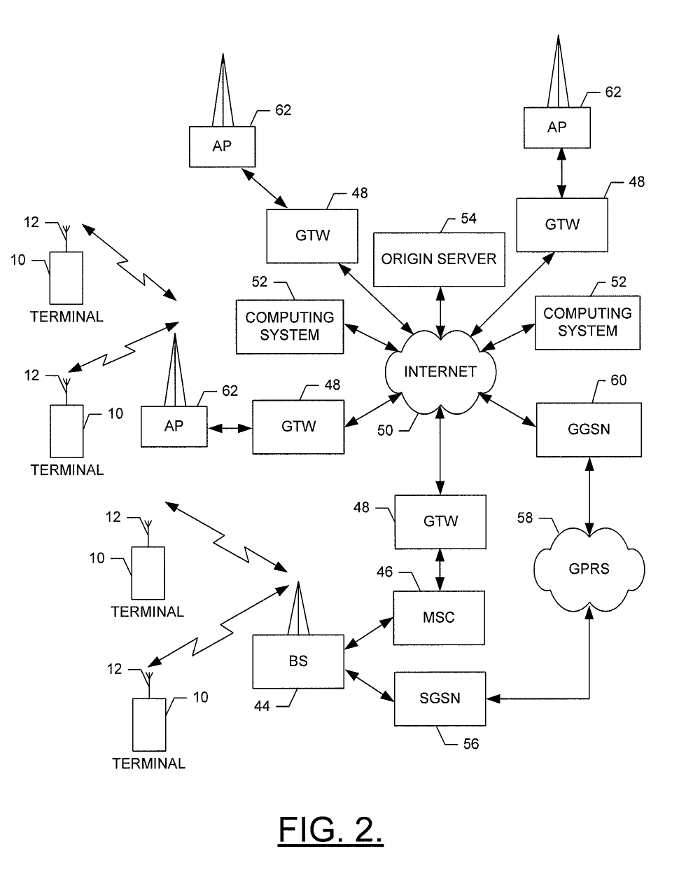

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a UMTS network employing WCDMA radio access technology. Some narrow-band analog mobile phone service (NAMPS), as well as total access communication system (TACS), network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including wireless LAN (WLAN) techniques such as IEEE 802.11 (e.g., 802.11a, 802.11b, 802.11g, 802.11n, etc.), world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including universal serial bus (USB), LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1, and a network device of the system of FIG. 2 in order to, for example, execute applications or establish communication (for example, for purposes of content sharing) between the mobile terminal 10 and other mobile terminals. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a camera, server, personal computer or other device, absent any communication with the system of FIG. 2.

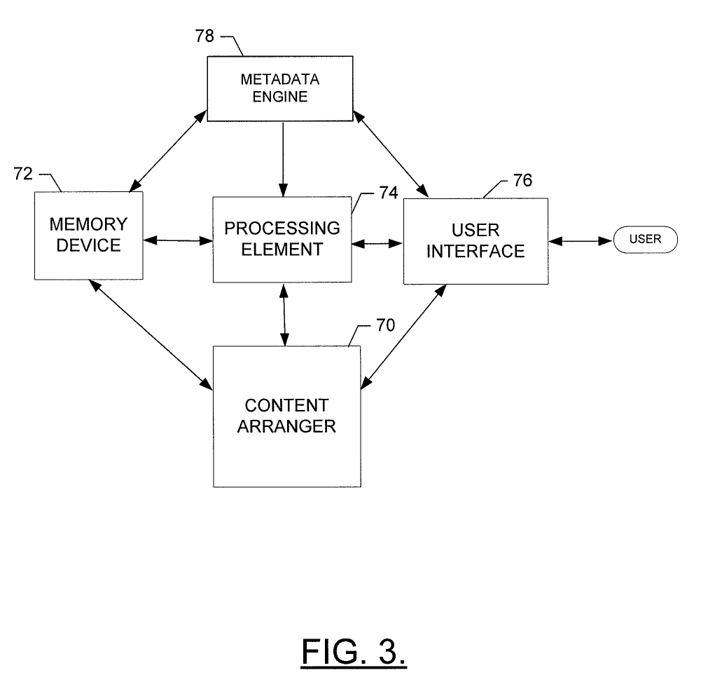

An exemplary embodiment of the invention will now be described with reference to FIG. 3, in which certain elements of an apparatus for providing presentation of content items of a media collection are displayed. The apparatus of FIG. 3 may be employed, for example, on the mobile terminal 10 of FIG. 1. However, it should be noted that the system of FIG. 3, may also be employed on a variety of other devices, both mobile and fixed, and therefore, the present invention should not be limited to application on devices such as the mobile terminal 10 of FIG. 1. In this regard, for example, a user of a personal computer may enjoy browsing content using embodiments of the present invention due to the ability provided by embodiments of the present invention to switch between viewing content items on the basis of one or more different themes. As an example of devices other than the mobile terminal of FIG. 1, the system of FIG. 3 may be employed on a personal computer, a camera, a video recorder, a handheld computer, a server, a proxy, etc. Alternatively, embodiments may be employed on a combination of devices including, for example, those listed above. It should also be noted that while FIG. 3 illustrates one example of a configuration of a system for providing presentation of content items of a media collection, for example, in a metadata-based content management environment, numerous other configurations may also be used to implement embodiments of the present invention and attributes or features other than metadata may form the basis for content management and presentation according to embodiments of the present invention. As such, it should be noted that the devices or elements described below may not be mandatory and thus some may be omitted in certain embodiments.

Referring now to FIG. 3, a system for providing presentation of content items of a media collection is provided. The system may be embodied in hardware, software or a combination of hardware and software for use by a device such as the mobile terminal 10. The system may include a content arranger 70, a memory device 72, processing element 74 and a user interface 76. In exemplary embodiments, the content arranger 70, the memory device 72, the processing element 74 and the user interface 76 may be in communication with each other via any wired or wireless communication mechanism. In this regard, for example, the user interface 76 may be in communication with at least the content arranger 70 and/or the processing element 74 to enable the content arranger 70 to generate a display of content items or categories of or relating to content items, or otherwise to render content stored in the memory device 72 or execute functions associated with content based, for example, on selections of the user made via a scrolling function. For example, a user may utilize the user interface 76 in order to direct the operation of a device (e.g., the mobile terminal 10) to import a file such as a multimedia file, capture an image or an audio/video sequence, download web content, create or download data or a document, etc., to thereby create a content item, which may have a corresponding type, associated metadata and/or other attributes, features and/or bases that can be used to organize categories of content items for display or rendering such that other categories may be accessed via a scrolling function in accordance with embodiments of the present invention as described in greater detail below. In an exemplary embodiment, the content item could be, for example, content processed according to a lossy or lossless audio, video or graphic compression technique. As such, for example, a free lossless audio code (FLAC), Moving Picture Experts Group-1 Audio Layer-3 (MP3) and numerous other types of audio compression techniques may be employed for content items according to embodiments of the present invention. Content items could also be video files, image files, audio files or other types of media content in various different formats. However, it should be noted that items in a particular category need not necessarily be content items. In this regard, items in a particular category could instead or additionally be links to sites, data or other information available via a network, album titles, movie titles, names of individuals, or various other headings that may serve as an identifier of a particular topic, media type, sub-category or the like.

It should be noted that any or all of the content arranger 70, the memory device 72, the processing element 74 and the user interface 76 may be collocated in a single device. For example, the mobile terminal 10 of FIG. 1 may include all of the content arranger 70, the memory device 72, the processing element 74 and the user interface 76. Alternatively, any or all of the content arranger 70, the memory device 72, the processing element 74 and the user interface 76 may be disposed in different devices. For example, the content arranger 70, the processing element 74 and/or the memory device 72 may be disposed at a server, while the user interface 76 may be disposed at a mobile terminal in communication with the server. Other configurations are also possible. In other words, embodiments of the present invention may be executed in a client/server environment as well as or instead of operation on a single device. As such, for example, in an embodiment where the memory device 72 is located at a server, the mobile terminal 10 may view content sorted and presented based on information stored or otherwise accessible to the mobile terminal 10 while the content associated with the metadata is actually stored at the memory device of the server. Thus, upon selection of a particular content item at the mobile terminal 10, the particular content item may be streamed, downloaded or otherwise communicated to the mobile terminal 10 from the server.

In an exemplary embodiment, the apparatus may also include a metadata engine 78, which may be embodied as or otherwise controlled by the processing element 74. The metadata engine 78 may be configured to assign metadata to each created object (or to selected ones of created objects) for storage in association with the created content item in, for example, the memory device 72. In an exemplary embodiment, the metadata engine 78 may be in simultaneous communication with a plurality of applications and may generate metadata for content created by each corresponding application. Examples of applications that may be in communication with the metadata engine may include, without limitation, multimedia generation, phonebook, document creation, calendar, gallery, messaging client, location client, calculator and other like applications. Alternatively, or additionally, content may be received from other devices by file transfer, download, or any other mechanism, such that the received content includes corresponding metadata.

The metadata engine 78 may be any device or means embodied in either hardware, software, or a combination of hardware and software configured to generate metadata according to a defined set of rules. The defined set of rules may dictate, for example, the metadata that is to be assigned to content created using a particular application or in a particular context, etc. As such, in response to receipt of an indication of event such as taking a picture or capturing a video sequence (e.g., from the camera module 37), the metadata engine 78 may be configured to assign corresponding metadata (e.g., a tag). The metadata engine 78 may alternatively or additionally handle all metadata for the content items, so that the content items themselves need not necessarily be loaded, but instead, for example, only the metadata file or metadata entry/entries associated with the corresponding content items may be loaded in a database.

Metadata typically includes information that is separate from an object, but related to the object. An object may be “tagged” by adding metadata to the object. As such, metadata may be used to specify properties, features, attributes, or characteristics associated with the object that may not be obvious from the object itself. Metadata may then be used to organize the objects to improve content management capabilities. Additionally, some methods have been developed for inserting metadata based on context. Context metadata describes the context in which a particular content item was “created”. Hereinafter, the term “created” should be understood to be defined such as to encompass also the terms captured, received, and downloaded. In other words, content may be defined as “created” whenever the content first becomes resident in a device, by whatever means regardless of whether the content previously existed on other devices. However, some context metadata may also be related to the original creation of the content at another device if the content is downloaded or transferred from another device. Context metadata can be associated with each content item in order to provide an annotation to facilitate efficient content management features such as searching and organization features. Accordingly, the context metadata may be used to provide an automated mechanism by which content management may be enhanced and user efforts may be minimized.

Metadata or tags are often textual keywords used to describe the corresponding content with which they are associated, but the metadata can in various embodiments be any type of media content. In various examples, the metadata could be static in that the metadata may represent fixed information about the corresponding content such as, for example, date/time of creation or release, context data related to content creation/reception (e.g., location, nearby individuals, mood, other expressions or icons used to describe context such as may be entered by the user, etc.), genre, title information (e.g., album, movie, song, or other names), tempo, origin information (e.g., artist, content creator, download source, etc.). Such static metadata may be automatically determined, predetermined, or manually added by a user. For example, a user may, either at the time of creation of the content, or at a later time, add or modify metadata for the content using the user interface 76.

Alternatively, the metadata could be dynamic in that the metadata may represent variable information associated with the content such as, for example, the last date and/or time at which the content was rendered, the frequency at which the content has been rendered over a defined period of time, popularity of the content (e.g. using sales information or hit rate information related to content), ratings, identification of users with whom the content has been shared, who has viewed or recommended the content or designate the content as a favorite, etc. In an exemplary embodiment, popularity of the content could further include feedback, comments, recommendations, etc. that may be determined either implicitly or explicitly, favorite markings or other indications of user satisfaction related to a content item that may be gathered from various sources such as via the Internet, radio stations, or other content sources. Explicit feedback may be determined, for example, from written survey responses, blog comments, peer-to-peer recommendations, exit polls, etc. Implicit feedback may be determined based on user responses to particular content items (e.g., lingering on a content item, number of hits, multiple viewings or renderings, purchasing the content item, etc.). Title information and/or origin information may be displayed, for example, in alphabetical order. Date/time related information may be presented in timeline order. Frequency, popularity, ratings, tempo and other information may be presented on a scale from infrequent to frequent, unpopular to popular, low to high, slow to fast, respectively, or vice versa.

The memory device 72 (e.g., the volatile memory 40 or the non-volatile memory 42) may be configured to store a plurality of content items and associated metadata and/or other information (e.g., other attribute or feature information) for each of the content items. The memory device 72 could reside on the same or a different device from the device navigating and rendering content. The memory device 72 may store content items of either the same or different types. In an exemplary embodiment, different types of content items may be stored in separate folders or separate portions of the memory device 72. However, content items of different types could also be commingled within the memory device 72. For example, one folder within the memory device 72 could include content items related to types of content such as movies, music, broadcast/multicast content (e.g., from the Internet and/or radio stations), images, video/audio content, etc. Alternatively, separate folders may be dedicated to each type of content. In any case, regardless of the physical storage location of the content items, the content arranger 70 may be configured to access the corresponding content items and arrange the content items in accordance with the description provided below to enable improved capabilities with regard to organization, browsing, selection and access of content.

In an exemplary embodiment, a user may utilize the user interface 76 to directly access content stored in the memory device 72, for example, via the processing element 74. The processing element 74 may be in communication with or otherwise execute an application configured to display, play or otherwise render selected content via the user interface 76. However, as described herein, navigation through the content of the memory device 72 may be provided by the content arranger 70 as described in greater detail below. It should also be noted that in some embodiments, the user interface 76 and the content may be located in separate devices. As such, the memory device 72 or another storage medium capable of serving the content to the device associated with the user interface 76 may reside, for example, on a server accessible over the Internet. The user may then navigate through the content using the user interface 76 (e.g., via metadata or tags as described herein) and, upon selection of a content item, the selected content item may be transferred from the remote memory device 72 or storage medium to the device associated with the user interface 76 for rendering.

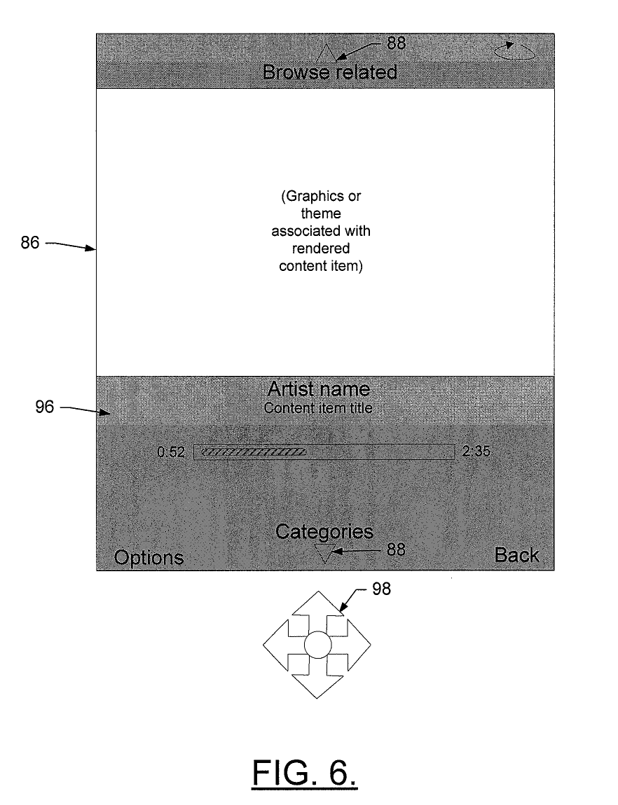

The user interface 76 may include, for example, the keypad 30 and/or the display 28 and associated hardware and software. It should be noted that the user interface 76 may alternatively be embodied entirely in software, such as may be the case when a touch screen is employed for interface using functional elements such as software keys accessible via the touch screen using a finger, stylus, etc. Alternatively, proximity sensors may be employed in connection with a screen such that an actual touch need not be registered in order to perform a corresponding task. Speech input could also or alternatively be utilized in connection with the user interface 76. As another alternative, the user interface 76 may include a simple key interface including a limited number of function keys, each of which may have no predefined association with any particular text characters. As such, the user interface 76 may be as simple as a display and one or more keys for selecting a highlighted option on the display for use in conjunction with a mechanism for highlighting various menu options on the display prior to selection thereof with the one or more keys. For example, the key may be a scroller 98 (e.g., a five way scroller comprising a scroll device capable of receiving four directional inputs such as up/down, right/left and a selection input) as shown in FIG. 6 comprising a scroll device with any number of directional input possibilities. User instructions for the performance of a function may be received via the user interface 76 and/or an output such as by visualization, display or rendering of data may be provided via the user interface 76. In an exemplary embodiment, responsive to an input received at the user interface 76, the content arranger 70 and/or the processing element 74 may be configured to execute a scrolling function to, for example, execute a link or function to display or render another item either within the same category or within another category dependent upon the particular scroll function as determined by the input received.

The content arranger 70 may be embodied as any device, circuitry or means embodied in either hardware, software, or a combination of hardware and software that is capable of performing the corresponding functions of the content arranger 70 as described in greater detail below. In an exemplary embodiment, the content arranger 70 may be controlled by or otherwise embodied as the processing element 74 (e.g., the controller 20 or a processor of a computer or other device). As such, the content arranger 70 may include or be embodied as arranging circuitry for performing the functions of the content arranger 70 as described in greater detail below. Processing elements such as those described herein may be embodied in many ways. For example, the processing element may be embodied as a processor, a coprocessor, a controller or various other processing means or devices including integrated circuits such as, for example, an ASIC (application specific integrated circuit).

In an exemplary embodiment, the content arranger 70 may be configured to provide a hierarchical organization of content items in which each of the content items may be organized according to type into a first and broadest level of organization. In this regard, the type of the content items may be determinable based on to which media classification the content item corresponds. For example, the type of a content item may be video, audio, image, or the like. In an exemplary embodiment, one or more types may be combined into a particular combined type such as, for example, image and video. In some embodiments, the type may be determined based on the file format or other indicators.

The content arranger 70 may be further configured to organize categories of items within each type. As such, the categories may include content items that are related to each other in a particular way that forms the basis for segregation of the items into a particular category. In other words, each of the categories may represent a different basis upon which to organize the content items. For example, the content arranger 70 may be further configured to organize the content items according to categories based on metadata associated with each of the content items. Alternatively or additionally, the content arranger 70 may be configured to organize the content items according to categories in which one or more of the categories include a plurality of sub-categories. In this regard, each of the sub-categories may include content items sharing a particular basis for organization such as, for example, a particular feature, attribute, metadata, tag, or the like.

In an exemplary embodiment, the content arranger 70 may be configured to organize the content items according to categories in which each category represents a different level of organization. Each level of organization may be related to each adjacent level of organization based on a decreasing scope for each subsequent level of organization as one “drills down” from the highest level of organization (e.g., the media level or type) to narrower levels of organization. In this regard, in one embodiment, the category (or sub-category) corresponding to the narrowest scope may include the content items and each subsequent category having a higher scope may include an item or series of items defining a corresponding increasingly broader basis for organizing the content items. The content arranger 70 may be further configured to provide an indication for each category with respect to the number of a currently viewed item with respect to a total number of items in the category and an indication with respect to the number of items in an adjacent category.

The content arranger 70 may be configured to arrange content for display or rendering such that a scrolling function may provide access from one content item to the next based on scrolling between content items in a same category, and/or the scrolling function may provide access from one content item to another category (or a content item in another category) based on scrolling between categories. In an exemplary embodiment, the content arranger 70 may be configured to enable access as described above based on a direction associated with the scroll function executed. In this regard, for example, within a given category, a scroll function executed in a first direction or along a first axis may provide access to other content items in the same category. Meanwhile, a scroll function executed in a second direction or along a second axis, that may in one embodiment be substantially perpendicular to the first axis, may provide the user with access to a different category or to one or further content items in the different category. As indicated above, the scroll function may be input via the user interface 76.

In an exemplary embodiment, content items sharing a category may be displayed along an axis corresponding to the first axis. In other words, a set of the content items that are each associated with a particular category may be displayed on a single column or row of content items and may be accessed by scrolling in the direction of the first axis (e.g., in a horizontal or vertical direction). However, it should be noted that the content items in the particular category may not necessarily be displayed simultaneously. In other words, only one of the content items, one content item and a portion of other content items, or a sub-set of the set of content items may be displayed at any given time.

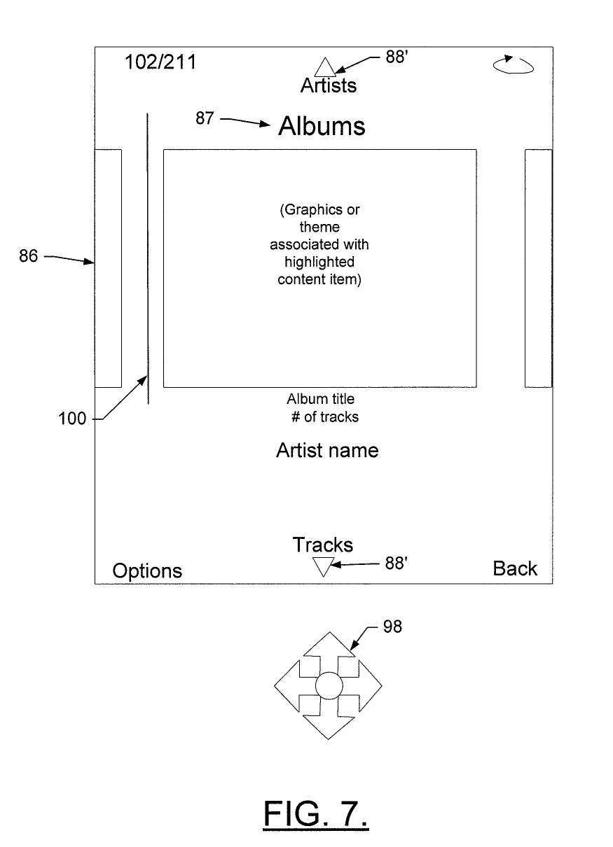

An ordering of the content items (or items or sub-categories) in the category may be provided by any mechanism. For example, time/date of creation or last rendering, frequency of rendering, popularity, alphabetical order, track order, release date, or numerous other ordering mechanisms may be provided. As such, scrolling along the first axis may change which content item is visible, highlighted (such as by being centrally located within the display or by another mechanism), or otherwise prominently presented by shifting the content items in accordance with the ordering provided to highlight (or display) the next content item in the ordering in the direction of the scroll. The content items may be on a continuous loop such that once all content items have been viewed or highlighted the content items are repeated. In this regard, for example, a barrier (e.g., see barrier 100 in FIG. 7) may be provided to indicate a border between ends of the ordering of the content items. Alternatively, when ends of the ordering of the content items are reached, no further scrolling along the corresponding axis may be possible in the corresponding direction scrolled to reach the end of the ordering. Optionally, once the barrier is reached, scrolling may stop automatically and further scrolling in the same direction may thereafter begin with additional input from the user (e.g., another push of the scroll key or scroll input via a touch screen) by looping to the other end of the ordering.

In an exemplary embodiment, in addition to organizing and/or arranging content items as described herein, the content arranger 70 (or the processing element 74) may be configured to execute other functionality as described below. For example, the content arranger 70 may be further configured to enable entry of a keyword or search term for search entries to enable quick location of content related to the entered keyword. The content arranger 70 may also be configured to enable entry of settings to define show or presentation limitations or restrictions in order to enable the automatic selection of content items for inclusion into a “smart show”. In this regard, for example, the user may be enabled to define a total number of items to be included in the show, whether looping should occur, whether time based sampling (e.g., to get a spread of content throughout a particular time period) should be employed, what type of media may be included and/or a specific topic/tag to form a theme of the show. The content arranger 70 may operate in similar fashion to produce a “best of” collection of music tracks or other content items.

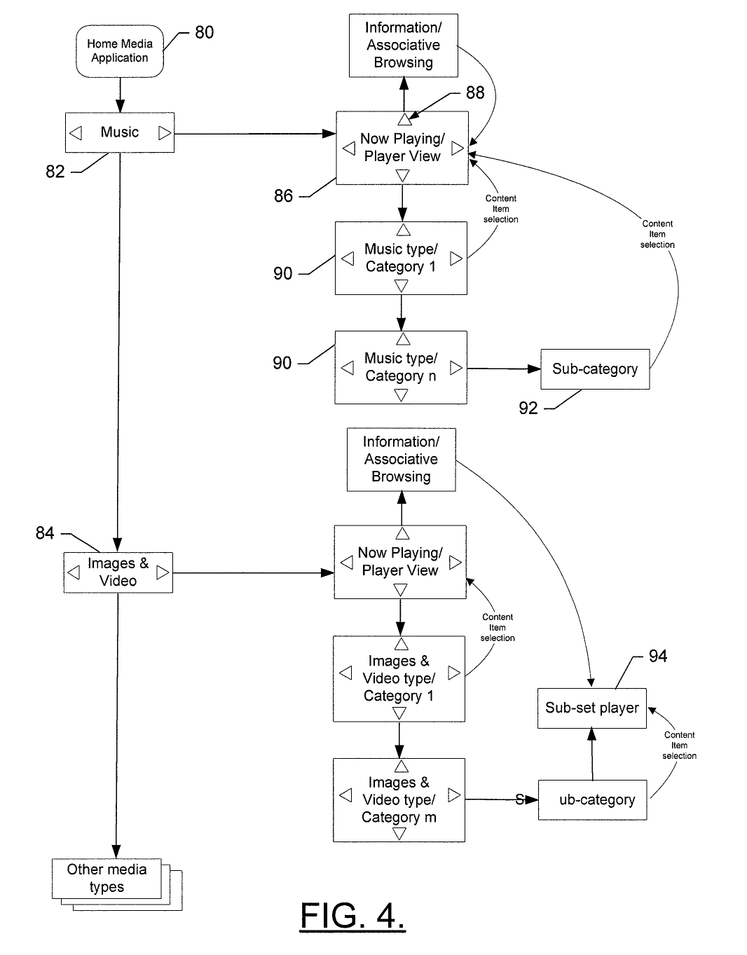

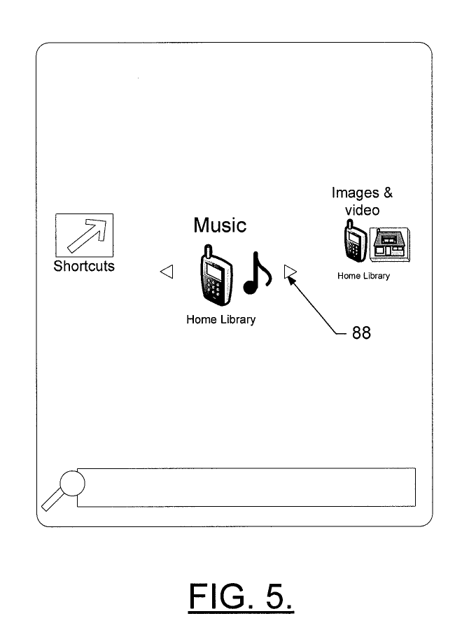

FIG. 4 illustrates an example of an organizational hierarchy according to an exemplary embodiment of the present invention. In this regard, for example, the content arranger 70 may correspond to a media application 80 comprising instructions for arranging content items and categories as described above and further for enabling navigation among the content items as also described herein. The media application 80, when executed, may provide a display of various media types and/or functions related to media content searching on a first level of organization. For example, as shown in FIG. 4, the first level of organization may include media of a first type such as music 82, media of a second type such as images and video 84 and media of various other types (e.g., television (TV) recordings (e.g., home or Internet TV), movies (e.g., home theater or online trailers) and the like). The media application 80 may also provide access to other services such as shortcuts (e.g., manually created or based on relevance), browsing services, search services, and/or the like. In an exemplary embodiment, in order to access each of the various media types, a scroll function executed along a particular axis (e.g., the first axis) may provide for a highlight of an icon or identifier associated with the corresponding various media types as indicated, for example, in FIG. 5. While scrolling through the various media types by scrolling along the first axis, for example, other media types (e.g., other icons) may be encountered. However, if a scroll operation is conducted along the second axis (or a selection function is executed), the media type corresponding to the currently highlighted icon or identifier may be selected.

For each media type, upon selection of the corresponding media type, a now playing or player view display may initially be encountered. An example of a now playing or play view 86 is illustrated in FIG. 6. The now playing or play view display corresponding to each different media type may be different. In this regard, each different now playing or play view display may be tailored to the type of media that corresponds therewith. For example, the now playing or play view 86 of the music 82 media type may include a musical theme. Upon initial access to the now playing or play view display 86 the corresponding theme may be displayed. Additionally or alternatively, information about the last rendered media content, the last executed function, or a next content item to be rendered in accordance with a playlist may be displayed. Additionally, an indicator 88 such as an arrow with a corresponding title or identifier may be presented in order to indicate which functions, categories or content items may be accessed via a corresponding scrolling function.

Referring to FIGS. 4 and 6, the indicator 88 may indicate, for example, that related information or a browsing function (e.g., as indicated by the “browse related” indicator) may be accessed by scrolling in a particular direction. Alternatively or additionally, the indicator 88 may indicate that different categories may be reviewed in order to access another level of organization as illustrated in FIG. 6. If a scrolling function is executed to access the different categories by scrolling, a category 90 may be entered in which various content items (of the corresponding media type) or sub-categories (e.g., sub-category 92) may be accessed. One or a plurality of categories may be present, each of which may be, for example, manually created by the user, automatically created based, e.g., on metadata, or pre-existing. As shown in FIG. 4 and described above, content within each category may be accessed via a scrolling function executed in a first direction or axis (e.g., the horizontal direction), while a different category may be accessed by executing a scrolling function in a second direction or axis (e.g., the vertical direction). If a content item within one of the categories or sub-categories is selected, the corresponding content item may be rendered and the view may return to the now playing or play view 86. Alternatively, as illustrated in FIG. 4, content items within sub-category 92 may be rendered via a sub-set player 94. Both the now playing or play view 86 and the sub-set player 94 may include functionality for rendering media of the corresponding media type.

As shown in FIG. 6, the now playing or play view 86 may also provide, for example, an indication of a total runtime associated with a currently playing content item and may also include an indication of the relative current position in the runtime with respect to the total runtime. In an exemplary embodiment, some or all of information such as the indicators 88, other navigation options, identification of the content item and/or corresponding information related to the content item (e.g., artist, album, composer, metadata, etc.), information indicative of the next content item to be played (e.g., according to a playlist), information related to the runtime, and the like, may be overlaid over the rendered content (or a themed background), for example, in a partially transparent overlay 96. The overlay 96 may also include other information, such as a total number of content items or a total number of content items in a playlist and the number, among the corresponding total, of the currently rendered content item. The overlay 96 may be displayed for only a predetermined amount of time after the execution of any function. Alternatively, the overlay 96 (or portions of the overlay 96) may be displayed continuously when the now playing or play view 86 is rendering content, or until turned off.

In an exemplary embodiment, informational elements providing information about a current or next content item could also be navigational elements. Such navigational elements may be useful, for example, when employed in connection with a touch user interface. Accordingly, for example, by touching a displayed artist's name, the user may quickly navigate to an artist view so that the corresponding artist may be highlighted. Alternatively, the user may quickly navigate (e.g., by touching a displayed artist's name) to a view listing the albums of the corresponding artist. Additionally or alternatively, there may not be any navigational elements and/or indicators (e.g., the indicator 88) displayed despite the fact that scrolling may still have the same results described herein.

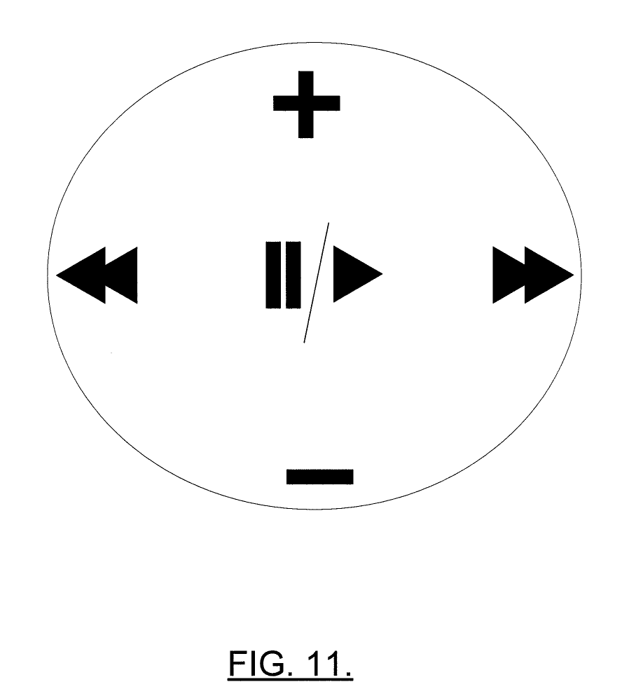

In an exemplary embodiment, pressing the scroller 98 in a predefined manner may execute play, pause, stop, fast forward, rewind, next, previous, increase/decrease volume, and/or other functions. In this regard, for example, one or more keys of the user interface 76 may be designated as mode change keys. As such, during normal operation, scrolling may operate as otherwise described herein. However, in response to selection of a mode change key, the scroller 98 may have new assigned functions as illustrated, for example, in FIG. 11. If a touch screen is employed, the illustration of FIG. 11 or another similar mechanism of indicating scroll functions that can be performed by dragging fingers to the left, right, up or down in accordance with the indications provided or by touching in specified locations may be provided. Selection of the mode change key again (or selection of a mode clearance key) may return the scroller 98 to normal operation. In one embodiment, scrolling in an axis other than the axis that changes to the category view or links to related information or browsing functions may enable the user to view a listing of recently rendered content items and/or queued content items.

In an exemplary embodiment, as shown in FIG. 6, if the indicator 88 (or one of the indicators) corresponds to a “browse related” function, the media application 80 may enable one click access (i.e., by scrolling in the direction indicated by the indicator 88) to related information and/or links associated with the current content item. In this regard, for example, if the content item being rendered is a song performed by a particular artist, or from a particular album, a link to a biography of the artist, to other works by the artist, to an online record store where the album or related albums may be purchased, to music of a similar genre, to similar artists based on, e.g., a web service classification or recommendation, etc., may be provided.

FIG. 7 illustrates an example of content items within a particular category according to an exemplary embodiment. As shown in FIG. 7, indicators 88′ may be included to indicate other categories that may be accessible via a scrolling function (e.g., via scrolling along the vertical axis). Meanwhile, scrolling along, e.g., the horizontal axis, may enable highlighting of adjacent or other content items within the corresponding category. As indicated above, a barrier 100 (or loop separator) may be presented between a first content item and last content item in the corresponding category to show when a complete cycle through content items in the category has been completed. A length of time for which the scroll function is executed (e.g., the length of time that the scroll key is depressed) may determine a speed of the scroll. When a scroll speed reaches a particular threshold, information may be added to the screen to provide the user with an indication of a position of the current content item with respect to all other content items in the category. Accordingly, even though the content items may be displayed for a very short time, the user may be enabled to keep a perspective on at which portion of the collection of content items in the category the scroll function is currently operating.

Other categories may include standard categories that are pre-existing, manually generated categories, automatically generated categories, or any combination of the above mentioned and other categories. As shown in FIG. 7, which illustrates an example of music related content items, information relating to the highlighted content item (e.g., the displayed content item (if only one is displayed), or the most prominently displayed content item) may be displayed either on an overlay (similar to the manner described above in reference to FIG. 6) or in another location of the display in situations in which a graphic indicative of the content item may be sized to provide sufficient space to display the information without obstructing a view of the graphic. The graphic may be an image, a video frame, a movie poster, an album cover, artwork, or any other material indicative or associated with the corresponding content item. Other information may also be displayed in connection with a particular graphic. For example, information indicative of the current category 87, the number of the item currently being rendered with respect to a total number of items in the category and/or a number of items in an adjacent category and/or an identification of the adjacent category. In an exemplary embodiment, the graphic for a particular item that is the last item in a category (e.g., an item adjacent to the barrier) may also include a link or otherwise change an existing link executable by scrolling (e.g., change one of the indicators 88′) to access related items or a browsing function instead of an adjacent category.

In an exemplary embodiment, a first level of organization may include the music 82 media type, a first category within the music 82 media type may represent a narrower level of organization comprising, for example, different genre categories of music such as pop, rock, R&B, etc. As such, the next level of organization of the content items may be a genre category. All content items associated with a particular genre may be accessible (albeit potentially via further scrolling or tunneling) via selection of a corresponding genre category. If pop, for example, were selected as a category (or sub-category) within the genre category, items corresponding to various pop artists may be provided as further categories (or sub-categories). Upon selecting (e.g., via scrolling vertically) a particular pop artist, a new category of albums associated with the particular pop artist may be accessed and the selected category (e.g., the selected album of the particular pop artist) may then include content items including the tracks from the selected album (or at least those tracks from the selected album that are available for rendering or purchase).

In another exemplary embodiment, in which the first level of organization includes the images and video 84 media type, images and/or videos may comprise content items organized on the basis of, for example, metadata associated with each corresponding content item may be used to associate each content item with one or more different categories. As such, in one exemplary embodiment, music related content items, for example, may be accessible in narrow scope categories and broader scope categories may represent collections of applicable narrow scope content items. Meanwhile, image and/or video content items, for example, may be accessible in various ones of different categories so long as the corresponding content item is associated with each of the different categories. In other words, in one embodiment, image/video hierarchy may enable access to the same content item in different categories or levels of organization, whereas music hierarchy may enable access to items having a scope commensurate with the corresponding level of organization. Thus, for music, narrow scope content items such as tracks may be only accessible at the narrowest level of organization, whereas broader scope content items such as albums may be accessible at a broader level of organization.

With respect to image/video related content items, location, date, time and other metadata associated with content items may be used to associate content items with different corresponding categories. However, as indicated above, other manually or automatically created categories (and pre-existing categories) may also exist such as photo albums, a view of thumbnails, etc. As such, content items may be associated with corresponding categories and scrolling (e.g., horizontally) within one category may enable access to, and if the content item is selected also rendering of, other content items in the category as described above. Meanwhile scrolling in another direction (e.g., vertically) may enable access to other categories. When a content item is playing or being rendered, as described above, related items or a browsing function may be accessed by scrolling in one direction (e.g., up), while access to the categories may be provided for scrolling in another direction (e.g., down).

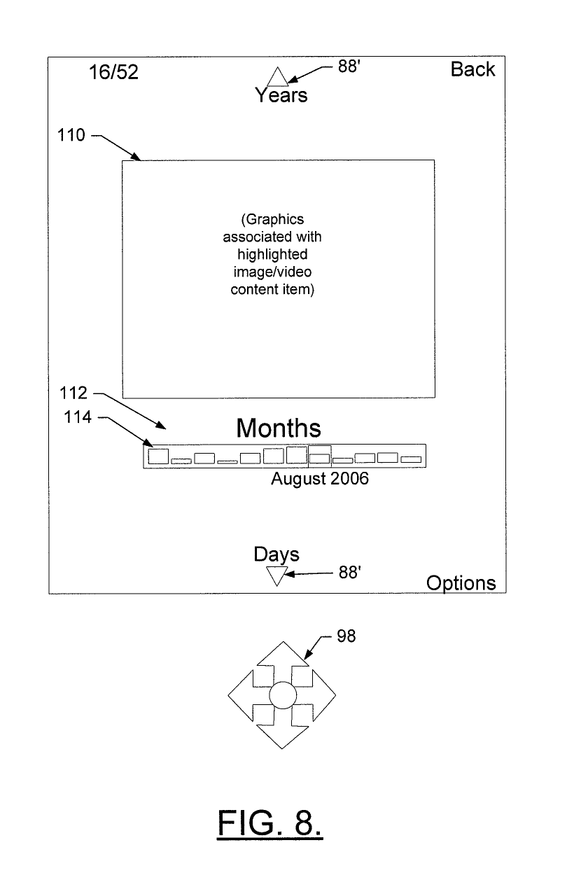

FIG. 8 illustrates an example of a video or image media type content item 110. In this example, the content item 110 may be within a month category. An overlay 112 may appear initially after the content item 110 is highlighted or otherwise displayed. The overlay 112 may indicate the current category and information related to the category (or related to the content item 110). In an exemplary embodiment, a bar graph 114 may be provided to indicate a location of the content item 110 with respect to its corresponding category and/or with respect to an adjacent category (e.g., day or year). In this regard, the bar graph 114 may include bins indicative of the number of content items in each bin. The highlighted bin may correspond to the bin (or category) of the current content item. The remaining bins may each be indicative of corresponding other categories associated with the current level of organization. The heights of the bars associated with each bin may indicate the relative numbers of content items in each of the bins. In an exemplary embodiment, selection of the content item 110 may cause the corresponding media player (e.g., associated with the now playing or play view display 86) to display the content item in a full screen view. Alternatively, a function for displaying the content item 110 in a full screen view may be accessible by scrolling.

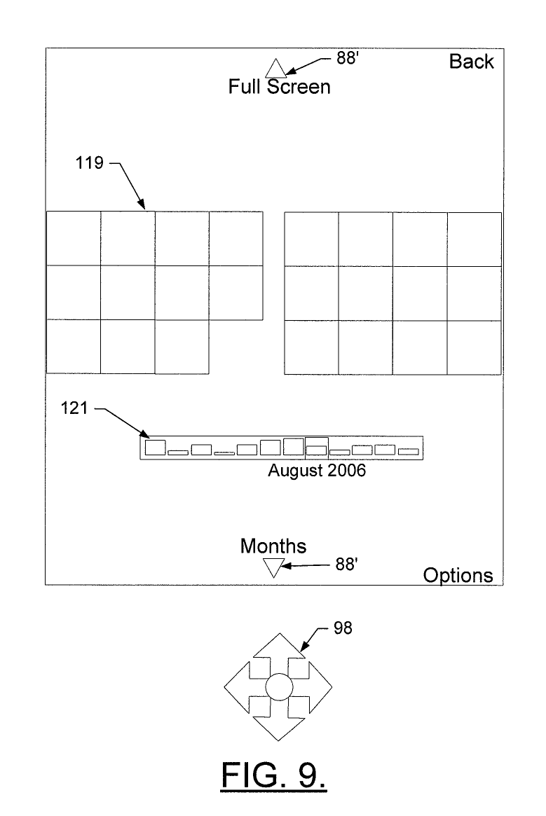

It should be noted that although FIG. 8 illustrates only a single content item being displayed while traversing content within a category, other embodiments may provide for multiple content items to be visible at a time. For example, all or a predetermined number of the tracks of a selected album may be visible at one time. Similarly, a plurality of thumbnail size images, video frames, movie posters, etc., each representing a corresponding content item, may all be visible (e.g., in a grid format) at one time as indicated in FIG. 9. Accordingly, the user may use the scroller 98 (perhaps after a mode shift) to highlight one of the multiple displayed items (or a highlighted item may be centrally or prominently displayed). In one embodiment, the user may select individual content items to add to a playlist or to order the content items for a slideshow or other presentation. A dedicated key of the user interface 76 may be provided for selection in this manner.

FIG. 9 illustrates an example of a month category of content items (e.g., images or video clips), in which the content items are presented in a thumbnail format comprising a plurality of thumbnails 119. In an exemplary embodiment, the thumbnail images representing the content items may have no space between them for a current level of organization, but content for the given level of organization that is related to adjacent content that would fall across the next higher level of organization may have a space divider therebetween. For example, as indicated in FIG. 9, thumbnails for given days within the same month may have no space between them. However, at a dividing line between months, a space may be provided. Moreover, an overlay indicative of the month/year of the content across the dividing line may also be provided (e.g., when the user crosses the dividing line indicated by a space between thumbnail content items, an overlay 121 of the next or previous month may be provided). Of note, the overlay 121 could be presented over the thumbnails 119 or offset from the thumbnails 119 as indicated in FIG. 9. Accordingly, the material of the thumbnails 119 may be presented in a timeline instead of as full screen images. Selection of a particular content item may bring up a portrait or full screen image of the content item for rendering, depending upon user preference, which may be predetermined or indicated by further selection.

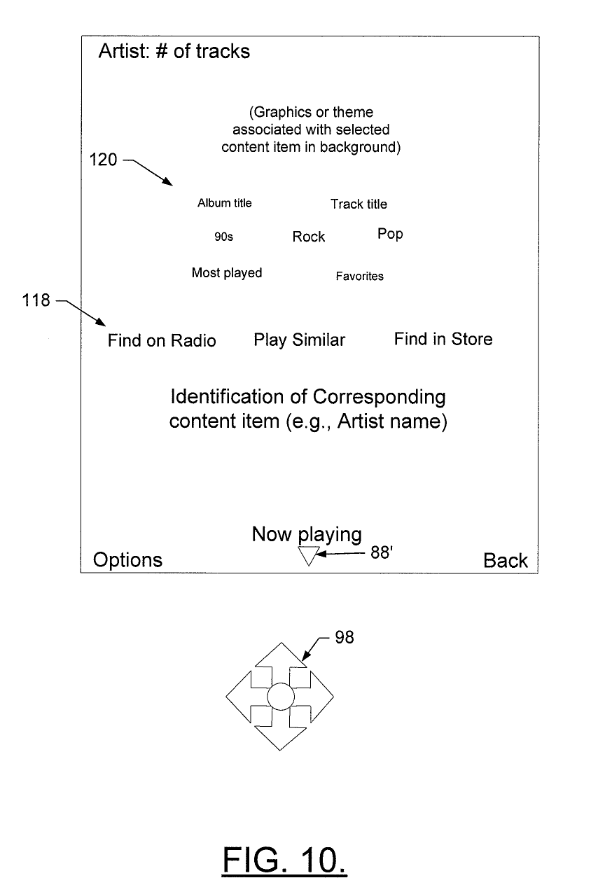

As indicated above, associative browsing may be launched with a scroll function (e.g., from the now playing or play view display 86). In this regard, FIG. 10 illustrates an example of an associative browsing function that may be performed in accordance with embodiments of the present invention. For example, when the “browse related” function is executed, the screen of FIG. 10 may be displayed for the topic or content item in connection with which the “browse related” function was executed. As indicated in FIG. 10, the browsing function may enable access (e.g, via links) to more media related to the corresponding content item (e.g., other albums, books, songs, categories, information, etc., related to the content item). In an exemplary embodiment, links to other functions 118 or sources of information or content may also be provided. For example, local radio stations playing a particular genre of music may be linked to, similar music may be accessed, online stores may be accessed to enable item purchases, etc. In one embodiment, related links and/or information may be presented in a tag cloud 120 as shown in FIG. 10, but other presentation styles are also possible. In exemplary embodiments, the tag cloud 120 may present individual tags for selection or, for example, may also be used for scrolling within a currently highlighted tag. In this regard, when a user selects (e.g., opens) an individual tag from the tag cloud 120, the resulting content associated with the tag can be browsed by other navigational views (e.g., for images the application can open full screen mode for browsing the results). On the other hand, the user could move the focus on a particular tag in the tag cloud 120 and browse content associated with the particular tag by scrolling (e.g. with left and right navigational keys). In the latter case, the user may not need to move away from an “associative browser” view, but the application could display small preview thumbnails, e.g., in the top portion of the display or in the background of the display, thereby displaying related items. Additionally, although a single thumbnail might be displayed; previous and next thumbnails could also be displayed. When tags are browsed (e.g., by sideways scrolling), the tag names may dynamically change to represent the tags of the item that is currently highlighted. Accordingly, the currently navigated tag remains the same (since it is related to all the items that the user is currently navigating with respect to), but the other tags might change.

It should be noted that the axes described above need not be laid out in a linear fashion. Moreover, it should be understood that the axes need not be laid perpendicular to each other. Instead, for example, the axes could be provided in a three (or more) dimensional format. For example, a presence of axes that would extend into and/or out of the page at various different trajectories could be indicated by a symbol or an icon. A scroll function for accessing content in these “three dimensional axes” may be invoked by selection of a particular key, by voice command, an options menu, a pop-up window, a drop down menu, etc. In this regard, for example, device capabilities (e.g., display size, navigation mechanism, etc.) may be used to determine a number of axes that may be provided.

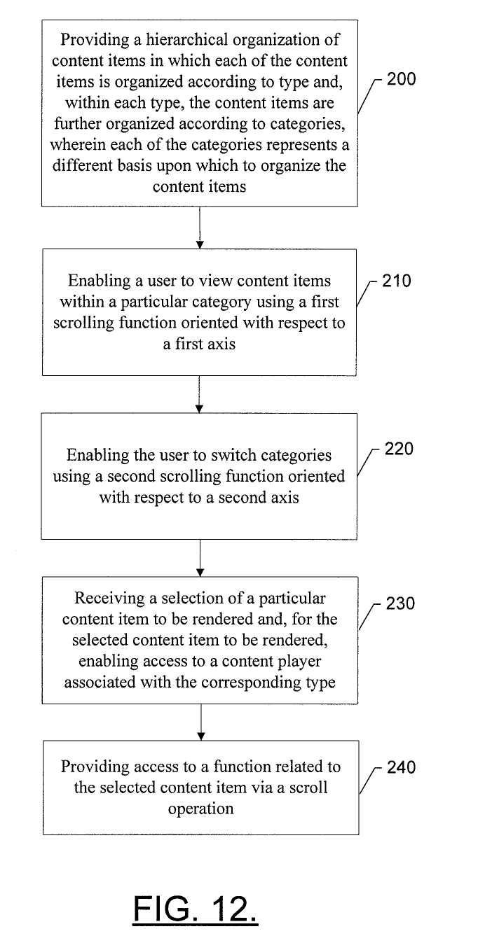

FIG. 12 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal or server and executed by a built-in processor in the mobile terminal or server. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing hierarchical navigation with respect to content items of a media collection as illustrated, for example, in FIG. 12 may include providing a hierarchical organization of content items in which each of the content items is organized according to type and, within each type, the content items are further organized according to categories at operation 200. Each of the categories may represent a different basis upon which to organize the content items. The method may further include enabling a user to view content items within a particular category using a first scrolling function oriented with respect to a first axis at operation 210 and enabling the user to switch categories using a second scrolling function oriented with respect to a second axis at operation 220. In an exemplary embodiment, the second axis being substantially perpendicular to the first axis.

In an optional embodiment, the method may further include receiving a selection of a particular content item to be rendered and, for the selected content item to be rendered, enabling access to a content player associated with the corresponding type at operation 230. Another optional operation of the method may include operation 240 of providing access to a function related to the selected content item via a scroll operation. In this regard, providing access to the function may include providing a link to a network for retrieving an item or information related to the selected content item via the network.

In an exemplary embodiment, operation 200 may include organizing the content items according to categories based on metadata associated with each of the content items or organizing the content items according to categories in which at least one of the categories includes a plurality of sub-categories in which each of the sub-categories includes content items sharing a particular basis for organization. As another alternative, operation 200 may include organizing the content items according to categories in which each category represents a different level of organization related to each adjacent level of organization based on a decreasing scope for each subsequent level of organization, in which the category corresponding to the narrowest scope includes the content items and each subsequent category having a higher scope includes a corresponding increasingly broader basis for organizing the content items. In an exemplary embodiment, the method may further include providing an indication for each category with respect to a number of a currently viewed item with respect to a total number of items in the category and further providing an indication with respect to a number of items in an adjacent category.

It should be noted that although exemplary embodiments discuss content, the content may include objects or items such as, without limitation, image related content items, video files, television broadcast data, text, documents, web pages, web links, audio files, radio broadcast data, broadcast programming guide data, location tracklog information, etc.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
providing a hierarchical organization of content items in which each of the content items is organized according to type and, within each type, the content items are further organized according to categories, wherein each of the categories represents a different basis upon which to organize the content items;
enabling a user to view content items within a particular category using a first scrolling function oriented with respect to a first axis; and
enabling the user to switch categories using a second scrolling function oriented with respect to a second axis.

2. A method according to claim 1, wherein enabling the user to switch categories using the second scrolling function oriented with respect to the second axis comprises providing the second scrolling function to scroll between the categories with the second axis being substantially perpendicular to the first axis.

3. A method according to claim 1, further comprising receiving a selection of a particular content item to be rendered and, for the selected content item to be rendered, enabling access to a content player associated with the corresponding type.

4. A method according to claim 3, further comprising providing access to a function related to the selected content item via a scroll operation.

5. A method according to claim 4, wherein providing access to the function comprises providing a link to a network for retrieving an item or information related to the selected content item via the network.

6. A method according to claim 1, wherein providing the hierarchical organization further comprises organizing the content items according to categories based on metadata associated with each of the content items.

7. A method according to claim 1, wherein providing the hierarchical organization further comprises organizing the content items according to categories in which at least one of the categories includes a plurality of sub-categories in which each of the sub-categories includes content items sharing a particular basis for organization.

8. A method according to claim 1, wherein providing the hierarchical organization further comprises organizing the content items according to categories in which each category represents a different level of organization related to each adjacent level of organization based on a decreasing scope for each subsequent level of organization, in which the category corresponding to the narrowest scope includes the content items and each subsequent category having a higher scope includes a corresponding increasingly broader basis for organizing the content items.

9. A method according to claim 8, further comprising providing an indication for each category with respect to a number of a currently viewed item with respect to a total number of items in the category and further providing an indication with respect to a number of items in an adjacent category.

10. A computer program product comprising at least one computer-readable storage medium having computer-readable program code portions stored therein, the computer-readable program code portions comprising:
a first executable portion for providing a hierarchical organization of content items in which each of the content items is organized according to type and, within each type, the content items are further organized according to categories, wherein each of the categories represents a different basis upon which to organize the content items;
a second executable portion for enabling a user to view content items within a particular category using a first scrolling function oriented with respect to a first axis; and
a third executable portion for enabling the user to switch categories using a second scrolling function oriented with respect to a second axis.

11. A computer program product comprising according to claim 10, further comprising a fourth executable portion for receiving a selection of a particular content item to be rendered and, for the selected content item to be rendered, enabling access to a content player associated with the corresponding type.

12. A computer program product comprising according to claim 11, further comprising a fifth executable portion for providing access to a function related to the selected content item via a scroll operation.

13. A computer program product comprising according to claim 10, wherein the first executable portion includes instructions for organizing the content items according to categories based on metadata associated with each of the content items.

14. A computer program product comprising according to claim 10, wherein the first executable portion includes instructions for organizing the content items according to categories in which at least one of the categories includes a plurality of sub-categories in which each of the sub-categories includes content items sharing a particular basis for organization.

15. A computer program product comprising according to claim 10, wherein the first executable portion includes instructions for organizing the content items according to categories in which each category represents a different level of organization related to each adjacent level of organization based on a decreasing scope for each subsequent level of organization, in which the category corresponding to the narrowest scope includes the content items and each subsequent category having a higher scope includes a corresponding increasingly broader basis for organizing the content items.

16. A computer program product comprising according to claim 15, further comprising a fourth executable portion for providing an indication for each category with respect to a number of a currently viewed item with respect to a total number of items in the category and further providing an indication with respect to a number of items in an adjacent category.

17. An apparatus comprising a processing element configured to:
provide a hierarchical organization of content items in which each of the content items is organized according to type and, within each type, the content items are further organized according to categories, wherein each of the categories represents a different basis upon which to organize the content items;
enable a user to view content items within a particular category using a first scrolling function oriented with respect to a first axis; and
enable the user to switch categories using a second scrolling function oriented with respect to a second axis.

18. An apparatus according to claim 17, wherein the processing element is further configured to receive a selection of a particular content item to be rendered and, for the selected content item to be rendered, enable access to a content player associated with the corresponding type.

19. An apparatus according to claim 18, wherein the processing element is further configured to provide access to a function related to the selected content item via a scroll operation.

20. An apparatus according to claim 17, wherein the processing element is further configured to organize the content items according to categories based on metadata associated with each of the content items.

21. An apparatus according to claim 17, wherein the processing element is further configured to organize the content items according to categories in which at least one of the categories includes a plurality of sub-categories in which each of the sub-categories includes content items sharing a particular basis for organization.

22. An apparatus according to claim 17, wherein the processing element is further configured to organize the content items according to categories in which each category represents a different level of organization related to each adjacent level of organization based on a decreasing scope for each subsequent level of organization, in which the category corresponding to the narrowest scope includes the content items and each subsequent category having a higher scope includes a corresponding increasingly broader basis for organizing the content items.

23. An apparatus according to claim 22, wherein the processing element is further configured to provide an indication for each category with respect to a number of a currently viewed item with respect to a total number of items in the category and further providing an indication with respect to a number of items in an adjacent category.

24. An apparatus comprising:
means for providing a hierarchical organization of content items in which each of the content items is organized according to type and, within each type, the content items are further organized according to categories, wherein each of the categories represents a different basis upon which to organize the content items;
means for enabling a user to view content items within a particular category using a first scrolling function oriented with respect to a first axis; and
means for enabling the user to switch categories using a second scrolling function oriented with respect to a second axis.

25. A method comprising:
providing, at a first device, a hierarchical organization of content items in which each of the content items is organized according to type and, within each type, the content items being stored at a second device are further organized according to categories by the hierarchical organization provided by the first device, wherein each of the categories represents a different basis upon which to organize the content items;
enabling a user to view, at the first device, content items within a particular category using a first scrolling function oriented with respect to a first axis;
enabling the user to switch categories using a second scrolling function oriented with respect to a second axis; and
receiving a selected content item from the second device in response to providing a selection of a content item to the second device.
